(19) United States
(12) Patent Application Publication
(10) Pub. No.: US 2013/0034472 A1
(43) Pub. Date: Feb. 7, 2013

(54) CATALYTIC CONVERTERS, INSERT MATERIALS FOR CATALYTIC CONVERTERS, AND METHODS OF MAKING

(71) Applicants: Timothy C. Cantrell, Pullman, WA (US); Giancarlo Corti, Moscow, ID (US); David N. McIlroy, Moscow, ID (US); Murray Grant Norton, Pullman, WA (US); Miles F. Beaux, II, Los Alamos, NM (US)

(72) Inventors: Timothy C. Cantrell, Pullman, WA (US); Giancarlo Corti, Moscow, ID (US); David N. McIlroy, Moscow, ID (US); Murray Grant Norton, Pullman, WA (US); Miles F. Beaux, II, Los Alamos, NM (US)

(73) Assignee: GONANO TECHNOLOGIES, INC., Moscow, ID (US)

(21) Appl. No.: 13/646,380

(22) Filed: Oct. 5, 2012

Related U.S. Application Data
(63) Continuation of application No. PCT/US2011/031304, filed on Apr. 5, 2011.
(60) Provisional application No. 61/341,738, filed on Apr. 5, 2010.

(51) Int. Cl. B01D 53/94; B82Y 30/00

(52) U.S. Cl. 422/177; 977/773; 977/768; 977/762; 977/810

(57) ABSTRACT

Catalytic converters and insert materials for catalytic converters comprising metalized nanostructures coated on metal or ceramic honeycomb substrates are described. The nanostructures can be bonded directly to the channel walls of the metal or ceramic honeycomb substrates, and generally extend approximately 0.1 mm into the open pore volume of the substrates. The nanostructured coating can be used to support various catalyst formulations, where the nanostructured coating can provide advantages such as increasing reactivity of the catalysts by providing higher accessible surface area, decreasing light-off temperature through enabling smaller particle size of the catalysts, improving durability and lifetime of the catalysts through increased thermal stability, decreasing costs through reduced amounts of precious metals, and/or functioning as a filter for particulate matter.

### CROSS REFERENCE TO RELATED APPLICATIONS

This application is a Continuation of PCT/US2011/031304 filed Apr. 5, 2011, and entitled Catalytic Converters, Insert Materials for Catalytic Converters, and Methods of Making, which claims priority to and the benefit of U.S. Provisional Patent Application Ser. No. 61/341,738, filed on Apr. 5, 2010, and entitled Catalytic Converters and Methods of Making Same, the disclosure of both which are incorporated by reference herein in their entirety.

### FIELD

This application relates to catalytic converters that comprise nanostructures at least partially coated with metal-containing nanoparticles. These catalytic converters can be used for mobile and/or stationary applications for pollution control.

### BACKGROUND

Air pollution generated from automobile emissions is an area of general concern because of the environmental impact associated with such emissions and the growth in the world vehicle fleet. Catalytic converters had widespread rollout in the U.S. market starting in 1975 by the Engelhard Corporation. Since then, catalytic converters have become the standard in exhaust pollution control. Significant developments in automotive catalytic converters have occurred, with three-way catalysts (TWC) representing probably the most important of these developments. Their efficiency at reducing carbon monoxide (CO), nitrogen oxides (NOₓ), and unburned hydrocarbons (HC) resulted in a dramatic reduction in air pollution even as more cars were added to the road. However, major challenges remain, particularly because of regulatory demands for increased performance. Design goals for next-generation catalytic converters include: (1) high activity and selectivity; (2) very fast light-off (<10-20 seconds); (3) high thermal stability; and (4) high oxygen storage capacity. See J. Kaspar, P. Fornasiero, and N. Hickey, “Automotive Catalytic Converters: Current Status and Some Perspectives,” Catalysis Today, vol. 77, pp. 419-449 (2003). An additional desirable goal is to reduce the precious group metal content thereby lowering costs.

To date, the majority of research has focused on engineering the catalyst and the wash-coating process of applying the catalyst to catalytic converter insert materials to achieve these goals. Significantly less research has gone into making more efficient use of the precious metal catalyst and improving the performance of the catalytic converter by means of engineering the substrate supporting the catalyst.

Three-way catalytic converters, those that both oxidize CO and hydrocarbons and reduce NOₓ, are the most widely used catalytic converters on the market today. Because of the requirements for stoichiometric combustion, catalytic converters using TWC mainly are used in gasoline engine applications, which are designed to run slightly above the stoichiometric point, i.e., between 14.6 and 14.8 parts air to 1 part fuel (by weight). Three-way catalytic converters are less effective in diesel and lean burn gasoline engine applications, where there is more oxygen than required and the reduction of NOₓ is not favored.

Alternatives to three-way catalytic converters for lean burn applications require a NOₓ storage catalyst. The most promising material for this purpose is barium oxide (BaO). BaO stores the NOₓ during the oxidizing part of the process, until the engine management computer of the fuel injection system determines and adjusts the air/fuel ratio by periodically injecting fuel into the exhaust stream to make the gas stream reducing for NO_{R} conversion. While BaO is very effective for NOₓ storage, it suffers from a significant limitation that on a flat surface, the majority of the particles tend to agglomerate during the conversion process which renders the material inactive. See e.g., J. Szanyi, J. H. Kwak, J. Hanson, C. Wang, T. Szailer, and C. H. F. Peden, “Changing Morphology of BaO/Al₂O₃ During NO₂ Uptake and Release,” J. Phys. Chem. B, vol. 109, pp. 7339-7344 (2005).

Diesel engine emission control systems also require particulate filters for removing particulate matter (PM). In current catalytic converter technology for lean burn diesel engines, the emission control system therefore includes two separate components: a catalytic converter for oxidizing CO and hydrocarbons, and a separate device for capturing and reducing carbon particulate matter (PM) and NOₓ. While there is ongoing research to integrate diesel particulate filters and the oxidation catalyst, there is little research towards the four-way integration of (1) oxidiation of CO, (2) oxidation of hydrocarbons, (3) capture and destruction of carbon PM, and (4) reduction of NO_{R} in a single monolith. Further, as regulations continue to restrict the number of small particles that can be emitted by diesel vehicles, the importance of finding a highly efficient filter that does not compromise performance and fuel mileage becomes increasingly important.

### SUMMARY

In light of the foregoing, it is an object of the present teachings to provide emission control systems and components, for example, catalytic converters and particulate filters, that can overcome various deficiencies and shortcomings of the prior art, including those outlined above.

Specifically, it can be an object of the present teachings to provide catalytic converter insert materials, where the catalytically active components of such insert materials have improved activity, selectivity, and/or thermal stability compared to existing insert materials.

It can be another object of the present teachings to provide catalytic converter insert materials, where the catalytically active components of such insert materials retain comparable activity and/or selectivity at a lower platinum group metal content compared to existing insert materials.

It can be another object of the present teachings to provide particulate filters having one or more catalytically active components, where such catalytically active components have improved activity, selectivity, and/or thermal stability compared to existing catalyzed particulate filters.

It can be another object of the present teachings to provide particulate filters having one or more catalytically active components, where such catalytically active components retain comparable activity and/or selectivity at a lower platinum group metal content compared to existing catalyzed particulate filters.

It can be another object of the present teachings to provide catalytic converter insert materials and/or catalyzed particulate filters, where the insert materials and/or filters are able to remove larger amounts of particulate matter and/or particulate matter of smaller sizes.

It can be another object of the present teachings to provide a four-way catalytic converter capable of (1) oxidiation of CO, (2) oxidation of hydrocarbons, (3) capture and destruction of carbon particulate matter, and (4) reduction of NOₓ in a single monolith.

Other objects, features, and advantageous of the present teachings will be apparent from the summary and the following descriptions of certain embodiments, and will be readily apparent to those skilled in the art knowledgeable regarding emission control systems. Such objects, features, benefits and advantages will be apparent from the above as taken into conjunction with the accompanying examples, data, figures and all reasonable inferences to be drawn therefrom, alone or with consideration of the references incorporated herein.

In part, the present teachings can be directed to catalytic converter insert materials and/or particulate filters that comprise nanostructures at least partially coated with metal-containing nanoparticles. The nanostructures can be deposited on industry-standard substrates using low-temperature, high-yield, and reproducible processes. The insert materials and/or particulate filters can be incorporated into an emission control system for mobile and/or stationary internal combustion engine applications.

In one aspect, the present teachings provide a catalytic converter insert material that can be inserted in an exhaust line from an internal combustion engine, where the insert material includes a monolithic substrate having a plurality of channels defined by a lattice of interior walls, and a disordered array of nanostructures attached to at least a portion of the interior walls defining each channel, where each nanostructure includes at least two different types of metal-containing (e.g., metals, metal alloys, metal oxides, and the like) nanoparticles deposited thereon. In various embodiments, at least one type of the metal-containing nanoparticles can include a metal catalyst (that catalyzes oxidation of carbon monoxide, hydrocarbons, and/or soot particles; and/or catalyzes reduction of nitrogen oxides), thereby providing a nanostructure-supported catalyst or simply, a nanostructured catalyst. For example, the nanostructures can be coated with at least one type of metal nanoparticles, wherein the metal is selected from the group consisting of Au, Ag, Cu, Fe, Ni, Pt, Pd, Ir, Rh, Ru, Mn, and Co. The metal nanoparticles also can be an alloy or a combination (for example, a shell of a first metal encapsulating a core of a second metal) of two or more metals selected from the group consisting of Au, Ag, Cu, Fe, Ni, Pt, Pd, Ir, Rh, Ru, Mn, and Co. In various embodiments, the metal nanoparticles can include a precious metal, and particularly, a platinum group metal such as platinum, palladium, and/or rhodium.

As used herein, a nanostructure having at least one type of metal-containing nanoparticles deposited thereon can be described as a “metalized nanostructure.” Typically, an average cross-sectional dimension of the nanoparticles is at most half an average cross-sectional dimension of the nanostructures. The disordered array of metalized nanostructures provides a macroporous network comprising accessible catalytic sites that can adsorb one or more reactants in a reaction to be catalyzed (for example, O₂ in the oxidation of CO and/or hydrocarbons into carbon dioxide and water, and/or NOₓ in the reduction of nitrogen oxides into nitrogen and oxygen).

The catalytic activity and/or selectivity of the nanostructured catalysts can be modified to tune the catalyst for use in catalyzing a particular reaction. In some variations, the catalytic activity and/or selectivity of a catalyst can be modified or tuned by selecting the size of accessible catalytic sites in the macroporous network. For example, for certain reactions, a catalyst comprising a macroporous network with relatively fewer accessible catalytic sites but having relatively large size of accessible catalytic sites may be preferred over a catalyst comprising a macroporous network with relatively more accessible catalytic sites but having relatively small size of accessible catalytic sites.

In some variations, the size of accessible catalytic sites can be tuned by adjusting the configurations (e.g., shapes or structure types and dimensions) of the nanostructures in the disordered array. In the disordered array, the nanostructures can be selected from the group consisting of nanowires, nanotubes, nanorods, nanosprings, and combinations thereof. In some variations, a majority of the nanostructures in the disordered array can be rod-like. In other variations, a majority of the nanostructures can be coils (i.e. nanosprings). The nanostructures in a disordered array can have similar structure types (e.g., essentially all nanosprings) or different structure types (e.g., a mixture of nanowires and nanosprings as may be grown by changing growth conditions, so that nanosprings grow upon a mat of nanowires already laid down for instance, or vice versa). Further, the nanostructures in a disordered array can have similar dimensions (e.g., having similar cross-sectional dimensions or lengths) or different dimensions (e.g., a mixture of relatively thick nanostructures with relatively thin nanowires or a mixture of relatively long nanostructures with relatively short nanostructures). Alternatively to or in addition to varying the nanostructure configurations in a disordered array, the size of accessible catalytic sites can be tuned by selecting a density of nanostructures in the disordered array. In some variations, both the configurations and density of the nanostructures in the disordered array can be varied to adjust a size of accessible catalytic sites. Further, the catalytic activity and/or selectivity of the nanostructured catalysts can be modified by selecting the composition of the nanostructures. In various embodiments, the nanostructures can be composed of a refractory metal oxide. For example, the nanostructures can be composed of silica (SiO₂).

In addition, the catalytic activity and/or selectivity of the nanostructured catalysts can be modified by selecting at least one of a metal contained in the nanoparticles and the average cross-sectional dimension of the nanoparticles. In some variations, the compositions of the nanoparticles and nanostructures can be selected so that an electronic interaction between the nanostructures and the nanoparticles affects the activity of the catalyst. In certain embodiments, the nanostructures can be coated with metal oxide nanoparticles (or nanocrystals). For example, the nanostructures can be coated with one or more types of metal nanoparticles and at least one type of metal oxide nanoparticles. The metal oxide nanoparticles can comprise a metal oxide selected from the group consisting of barium oxide, cerium oxide, lanthanum oxide, zinc oxide, titanium dioxide, copper (I) oxide, copper (II) oxide, copper (I, II) oxide, cobalt (II) oxide, cobalt (III) oxide, cobalt (IV) oxide, cobalt (II, III) oxide, cobalt (II, IV) oxide, and mixtures thereof.

In some cases, the distribution of nanoparticles on the nanostructures can be adjusted to modify the activity of the catalyst for certain reactions. In some variations, the nanoparticles can be distributed on the nanostructures such that a majority of the nanoparticles are generally isolated from each other. In some variations, the nanoparticles can be distributed on the nanostructures such that there is physical contact between at most about 30% of the nanoparticles.

Any composition and configuration of nanostructures described herein can be combined with any composition and size of nanoparticles described herein. For example, some catalysts can comprise silica nanostructures (e.g., nanosprings or nanowires) coated with gold, palladium, platinum, rhodium, or nickel nanoparticles. Some catalysts can comprise nanostructures (e.g., nanowires) consisting essentially of SiO₂ with palladium nanoparticles attached thereto. In some cases, a nanostructure (e.g., a SiO₂ nanowire or a SiO₂ nanospring) can be coated with one or more metal oxide nanoparticles (e.g., zinc oxide, titanium dioxide, cerium oxide, any phase of aluminum oxide, lanthanum oxide, copper oxide such as copper (I) oxide, copper (II) oxide or a mixture thereof, or cobalt oxide such as cobalt (II) oxide, cobalt (III) oxide, cobalt (IV) oxide, cobalt (II,III) oxide, cobalt (II,IV) oxide or a mixture thereof) and metal nanoparticles (e.g., Au, Ag, Cu, Pd, Pt, Ir, Rh, Ru, Fe, Ni, Co, Mn, or alloys or combinations thereof) can be attached to the metal oxide nanoparticles in concentration ratios from 0 to 1 with the metal oxide nanoparticles. The metal oxide nanoparticles can be deposited as the base layer on the nanostructure with the metal nanoparticles on top or visa versa. Any combination in a ternary, either one metal oxide and two differing metal nanoparticles or two metal oxides and one metal, or in a quaternary system, where the four components are two metal oxides and two metals or alloys, can be employed in any layering to enhance the catalytic conversion.

The present teachings also relate to methods for extending the catalytic activity of a metal catalyst at elevated temperatures by forming nanoparticles of the metal catalyst on a disordered array of nanostructures comprising nanosprings or a mixture of nanosprings and nanowires. The metal catalyst can include one or more platinum group metals such as platinum and/or palladium. More generally, the present teachings also relate to methods for catalyzing an exhaust stream purification reaction using the nanostructured catalysts disclosed herein. The methods comprise contacting an exhaust stream from an internal combustion engine with a catalytic converter insert material or a particulate filter incorporating the nanostructured catalysts. The methods also can comprise selecting a size of accessible catalytic sites in a macroporous network so as to adsorb or bind one or more reactants of the exhaust stream, where the macroporous network is formed from a disordered array of nanostructures and a plurality of metal-containing nanoparticles attached to the nanostructures. In addition, the methods can comprise selecting at least one of the metals contained in the nanoparticles and an average cross-sectional dimension of the nanoparticles to catalyze the reaction. A metal oxide or combination of metal oxides can be chosen to stabilize the metal nanoparticles at elevated temperatures, increase or enhance the nanoparticle dispersion, or act as an oxygen storage component or a NOₓ storage catalyst. An oxygen storage component has multi-valence state and can actively store and release oxygen under exhaust conditions. Typically, an oxygen storage component will comprise one or more reducible oxides of one or more rare earth metals. Examples of suitable oxygen storage components include ceria. An example of a NO storage catalyst is barium oxide.

In some variations of the methods, configurations of the nanostructures within the disordered array can be varied to change the size of accessible catalytic sites. For example, nanostructure configurations can be varied among nanorods, nanosprings, nanowires, nanotubes and combinations thereof. Further, cross-sectional dimensions and lengths of the nanostructures can be varied. Alternatively to or in addition to varying nanostructure configurations, nanostructure density within the disordered array can be varied to affect the size of accessible catalytic sites.

The nanoparticle and metal oxide or any combinations thereof can be chosen to enhance a reducing reaction or an oxidizing reaction. For example, in some variations, the methods can be used to catalyze the oxidation of carbon monoxide and unburnt hydrocarbons. Other methods can be used to catalyze a reduction of NOₓ, or effectively catalyze the combustion of diesel particulates. For example, palladium nanoparticles on silica nanostructures in some instances can be used to catalyze oxidation of unburned hydrocarbons and carbon monoxide in diesel exhaust.

The present teachings also encompass various devices incorporating the nanostructured catalysts described herein and systems incorporating such devices. Such devices can comprise a disordered array of nanostructures grown on the interior walls of a commercial cordierite honeycomb monolith. In another variation, the device can comprise a disordered array of nanostructures grown on the interior walls of a commercial metal honeycomb monolith. The present nanostructures can be grown on any 3-D matrix material, such as fiberglass or fitted glass or fitted steel or any porous filter type material, for use in catalytic converter or particulate filter applications, and matched with a plurality of metal-containing nanoparticles disposed on the nanostructures to form a disordered array of metalized nanostructures. The combination of honeycomb monolith coated with metalized nanostructures can be used as a hybrid catalytic converter insert material or a catalyzed particulate filter. In some variations, the array of nanostructures can be coated upon cordierite that has been pre-treated with a washcoat. These hybrid inserts can have application in both stationary and mobile applications, including but not limited to light and heavy automotive, rail locomotives, consumer products (lawn mowers, weed eaters, roto tillers, chain saws, trimmers, etc.), and power generation. These new catalytic inserts can be used in biomass, wood, diesel, gasoline, coal, oil and natural gas applications and can have a maximum operation temperature of up to about 1100° C.

In certain variations of the catalyst devices, the metal-containing nanoparticles disposed on the substrate and/or disordered array of nanostructures can have any suitable composition, particle size distribution, and spatial distribution. For example, in some variations, the nanoparticles can have a dimension from about 2 nm to about 100 nm, from about 2 nm to about 50 nm, from about 2 nm to about 20 nm, from about 2 nm to about 15 nm, or from about 2 nm to about 10 nm. The metal-containing nanoparticles can comprise one or more metals selected from the group consisting of Au, Ag, Pt, Pd, Rh, Ru, Cu, Fe, Ni, Co, Mn, Ir, and combinations thereof. In some variations, the nanoparticles can be distributed on the nanostructures such that a majority of the nanoparticles are generally isolated from each other. For example, there may be physical contact between at most about 10%, at most about 20%, at most about 30%, at most about 40%, or at most about 50% of the particles. In some variations, the nanoparticles can be distributed on the nanostructures such that there is physical contact between at most about 30% of the nanoparticles. If there is physical contact between particles, the contact may be such that the particles merely abut each other, but a boundary or relatively clear demarcation exists between two abutting particles. In some cases, a surface area to mass ratio of the nanoparticles on the substrate and/or nanostructures is at least about 50 m²/g.

The nanostructures in the disordered array can have a cross-sectional dimension in a range from about 5 nm to about 100 nm, or about 5 nm to about 500 nm. In some variations, at least some of the nanostructures in the disordered array can comprise SiO₂. In certain variations, at least some of the nanostructures in the disordered array can comprise a SiO₂ nanostructure that is at least partially coated with a single crystal and/or polycrystalline coating of a metal oxide, e.g., CeO₂, LaO₂, ZnO, Al₂O₃, ZrO₂, PdO, BaO, copper oxide such as copper (I) oxide, copper (II) oxide or a mixture thereof, or cobalt oxide such as cobalt (II) oxide, cobalt (III) oxide, cobalt (IV) oxide, cobalt (RIM oxide, cobalt (II,IV) oxide or a mixture thereof. Nanoparticles and metal oxides can be deposited such that there is intentional contact between the metal oxide and the metal nanoparticles.

Accordingly, certain embodiments of the present teachings can relate to a catalytic converter for purifying exhaust gases from an internal combustion engine. The catalytic converter can include a monolithic substrate having a peripheral surface, a supporting mat encircling the peripheral surface of the monolithic substrate, and a metal housing enclosing the monolithic substrate and the supporting mat. More specifically, the monolithic substrate can have a plurality of parallel channels extending therethrough, and disposed within at least a portion of each channel can be a disordered array of metalized nanostructures. The metalized nanostructures generally include at least one type of metal-containing nanoparticles that includes a platinum group metal. The metalized nanostructures also can include at least one type of metal oxide nanoparticles, where the metal oxide nanoparticles can function as an oxygen storage component, a stability enhancer, and/or a NOₓ adsorber. In one variation, the catalytic converter can be used to purify exhaust gases from a lean burn diesel engine, where the channel walls of the monolitic substrate are coated with a disordered array of metalized nanostructures comprising nanosprings or a mixture of nanosprings and nanowires coated with barium oxide and at least one platinum group metal (e.g., Pt, Pd, or Pt—Pd) nanoparticles.

In other embodiments, the present teachings can relate to a particulate filter that includes a monolithic substrate having a plurality of parallel channels separated by gas-permeable walls, wherein adjacent channels can be plugged at alternate ends, and attached to at least a portion of the gas-permeable walls defining each channel can be a disordered array of nanostructures, wherein each nanostructure can be coated with one or more types of metal-containing nanoparticles. The nanostructures can filter and trap smaller particulate matter than the gas-permeable walls of the monolithic substrate, while the metal-containing nanoparticles can catalyze oxidation and combustion of soot particles.

The present teachings also provide a vehicle emission control system that includes a catalytic converter for treating an exhaust flow from a vehicle engine as described above and a tail pipe through which the exhaust flow treated by the catalytic converter is discharged to the atmosphere. In some embodiments, the catalytic converter can include a monolithic substrate having a plurality of channels defined by a lattice of interior walls, wherein attached to at least a portion of the interior walls defining each channel is a disordered array of metalized nanostructures. The disordered array of metalized nanostructures can have a thickness between about 10 μm and about 200 μm, and each metalized nanostructure can comprise a nanostructure coated with a plurality of nanoparticles of at least one platinum group metal and a plurality of nanoparticles of at least one metal oxide selected from barium oxide, cerium oxide, and lanthanum oxide.

The present teachings further provide an exhaust system for a stationary engine. The exhaust system can include a catalytic converter, where the catalytic converter includes a metallic monolithic substrate having a plurality of channels defined by a lattice of interior walls, wherein attached to at least a portion of the interior walls defining each channel is a disordered array of metalized nanostructures. Each metalized nanostructure can comprise a nanostructure coated with a plurality of nanoparticles of at least one catalytic metal. The stationary engine can be a leaf blower engine, a trimmer engine, a brush cutter engine, a chainsaw engine, a lawn mower engine, a riding mower engine, a wood splitter engine, a snowblower engine, a weed eater engine, a roto tiller engine, or a chipper engine.

### BRIEF DESCRIPTION OF THE DRAWINGS

The following drawings, which are not necessarily to scale, depict selective embodiments and are not intended to limit the scope of the present teachings.

FIG. 1 is a scanning electron microscope (SEM) image showing an industry-standard cordierite monolith (101), the interior walls of which are coated with nanostructures (102) according to the present teachings.

FIG. 2 is an SEM image showing a cross section of a cordierite wall (201) coated on both sides with a mat of nanostructures (202).

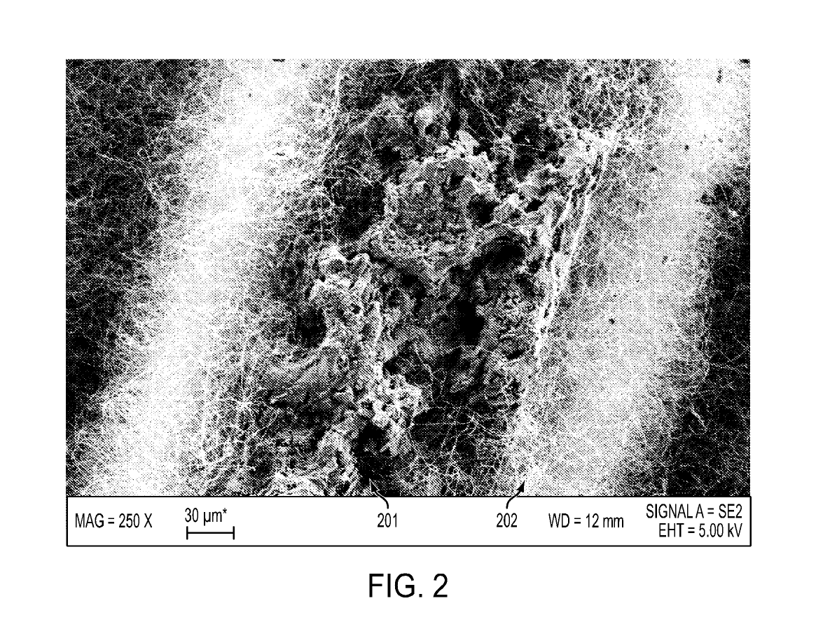

FIG. 3 is a transmission electron microscope (TEM) image of a SiO₂ nanospring (301) coated with metal (platinum) nanoparticles (302).

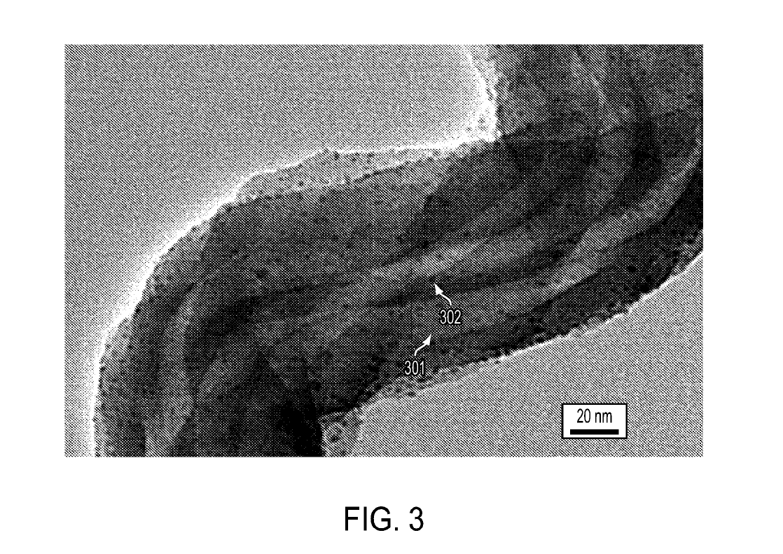

FIG. 4 is a TEM image of an ˜80 nm-diameter SiO₂ nanospring (402) coated with gold nanoparticles (401).

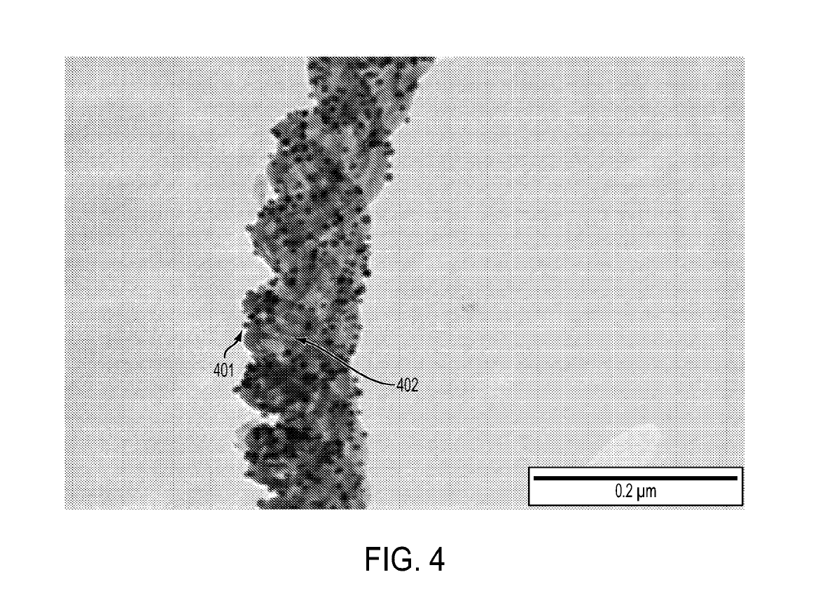

FIG. 5 is a schematic diagram of a cordierite honeycomb monolith (501), the interior walls of which are coated with nanosprings (502). The nanosprings extend into the channels (503) through which exhaust gases are introduced and converted catalytically.

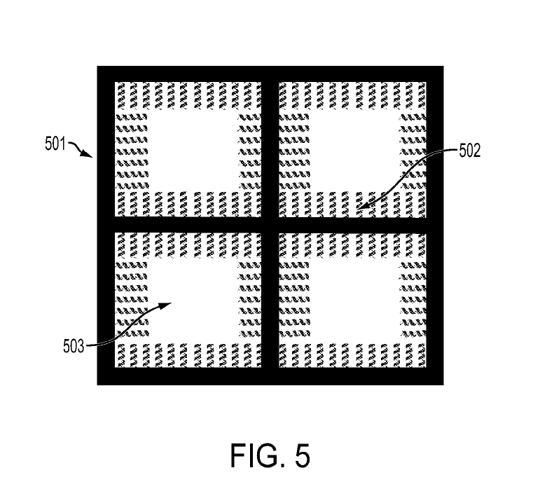

FIG. 6 is an SEM image showing a fiberglass filter substrate coated with nanosprings. One fiber of the fiberglass filter substrate is noted (601).

FIG. 7 is a schematic diagram illustrating an embodiment of the present teachings where a nanospring (701) is coated with one type of metal nanoparticles (702).

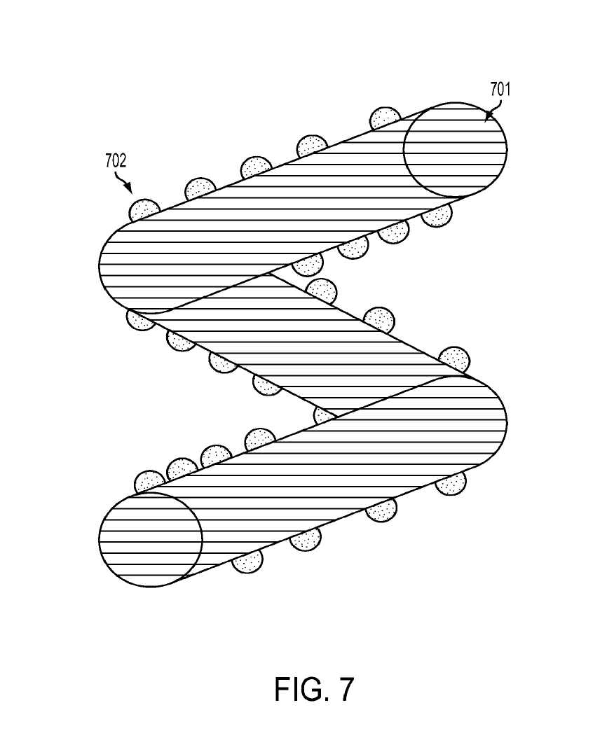

FIG. 8 is a schematic diagram illustrating an embodiment of the present teachings where a nanospring (801) is coated with two different types of metal nanoparticles (half-circles 802 and triangles 803).

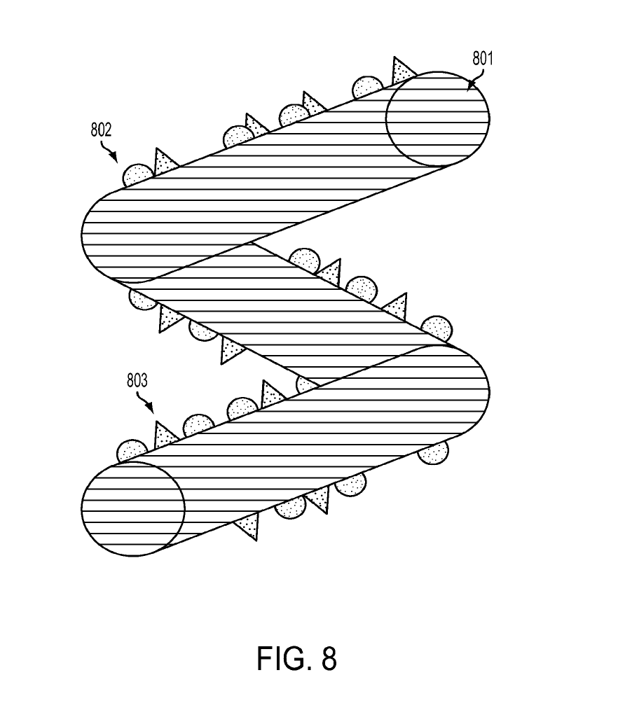

FIG. 9 is a schematic diagram illustrating an embodiment of the present teachings where a nanospring (901) is coated with two different types of metal-containing nanoparticles, specifically, one type of metal nanoparticles (half-circles 902) and one type of metal oxide nanoparticles (trapezoids 903).

FIG. 10 is a schematic diagram illustrating an embodiment of the present teachings where a nanospring (1001) is coated with three different types of metal-containing nanoparticles, specifically, two types of metal nanoparticles (half-circles 1002 and triangles 1003) and one type of metal oxide nanoparticles (trapezoids 1004). The different types of metal-containing nanoparticles can be deposited to provide different configurations, for example, all three can be deposited directly on the surface of the nanospring, the two types of metal nanoparticles can be deposited on the metal oxide nanoparticles, or the metal oxide nanoparticles can be deposited on the metal nanoparticles.

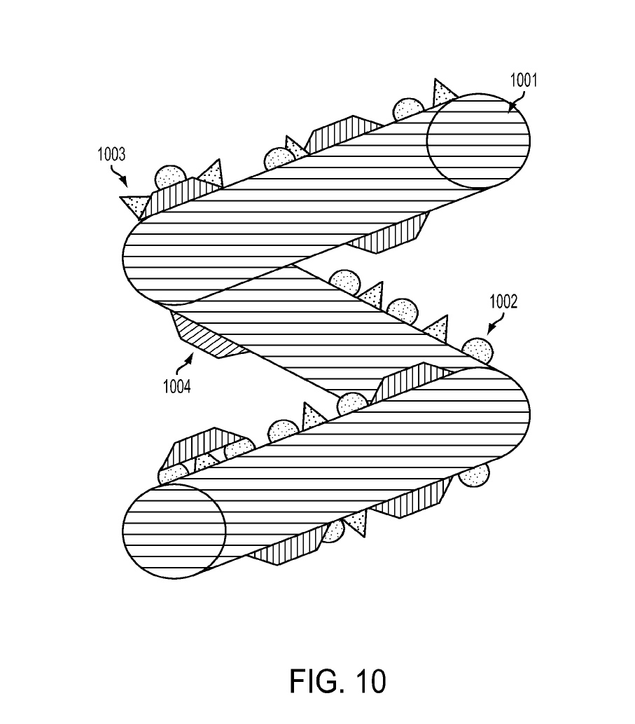

FIG. 11 is a schematic diagram illustrating an embodiment of the present teachings where a nanospring (1101) is coated with three different types of metal-containing nanoparticles, specifically, one type of metal nanoparticles (half-circles 1102) and two different types of metal oxide nanoparticles (trapezoids 1103 and ovals 1104). Different configurations are possible, some of which are shown.

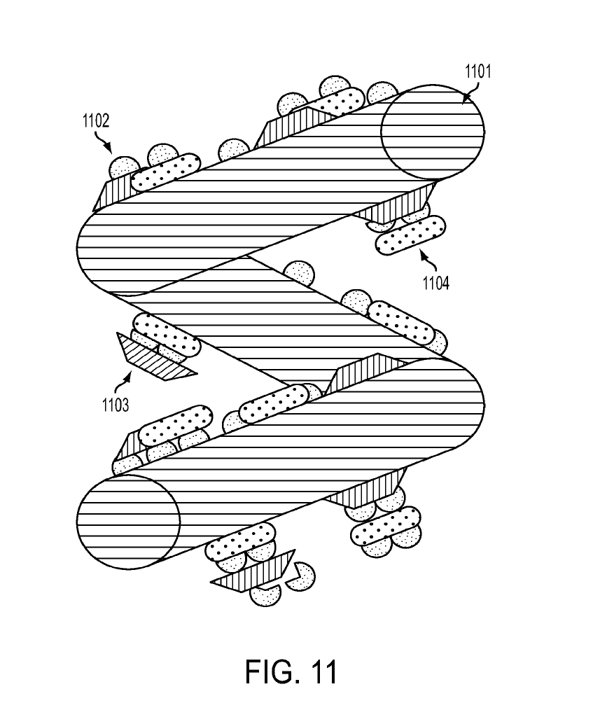

FIGS. 12A-12P are schematic diagrams showing all the possible deposition combinations of two metal oxides (1204 and 1205) and two metal nanoparticle types (1202 and 1203) on nanosprings (1201). For example, FIG. 12A shows two different types of metal oxide nanoparticles (1204 and 1205) deposited on a nanospring (1201), where the metal oxide nanoparticles themselves are coated with two different types of metal nanoparticles (1202 and 1203).

FIG. 13 is a schematic diagram showing the possible size reduction of a nanospring-enabled catalytic converter insert (1301) vs. a conventional catalytic converter insert (1302).

FIG. 14 is a schematic diagram showing one possible insert configuration utilizing a porous filter-type substrate coated with nanostructures as the filtering and catalyst support. The holder (1401) will hold several porous filter-type substrates (1402) in a way so that an exhaust gas stream passes through each of the filter-type substrates.

FIG. 15 compares the size distribution of nanospring-supported palladium nanoparticles before (1501) and after (1502) an aging treatment under a flow of air with a 10% relative humidity at 1073 K for 16 hours, which is used to simulate the aging conditions of a catalytic converter mounted on a 100,000-mile diesel vehicle.

FIG. 16 compares the size distribution of nanospring-supported platinum nanoparticles before (1601) and after (1602) an aging treatment under a flow of air with a 10% relative humidity at 1073 K for 16 hours, which is used to simulate the aging conditions of a catalytic converter mounted on a 100,000-mile diesel vehicle.

### DETAILED DESCRIPTION

Throughout the application, where compositions are described as having, including, or comprising specific components, or where processes are described as having, including, or comprising specific process steps, it is contemplated that compositions of the present teachings also consist essentially of, or consist of, the recited components, and that the processes of the present teachings also consist essentially of, or consist of, the recited process steps. The use of the terms “include,” “includes”, “including,” “have,” “has,” or “having” should be generally understood as open-ended and non-limiting unless specifically stated otherwise. In addition, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition, an apparatus, or a method described herein can be combined in a variety of ways without departing from the spirit and scope of the present teachings, whether explicit or implicit herein. Also, the order of steps or order for performing certain actions is immaterial so long as the present teachings remain operable. Moreover, two or more steps or actions may be conducted simultaneously.

It should also be noted that, as used in this specification and the appended claims, the singular forms “a,” “an,” and “the” include plural referents unless the context clearly indicates otherwise. Reference to “about” a value or parameter herein includes (and describes) embodiments that are directed to that value or parameter per se and a ±10% variation from the nominal value or parameter unless otherwise indicated or inferred. For example, description referring to “about X” includes description of “X” and a ±10% variation from “X”. A description referring to a “range from about X to about Y” includes description of “X” and “Y” and values therebetween, a ±10% variation from “X” and “Y” and values therebetween, “X” and a ±10% variation from “Y” and values therebetween, and a ±10% variation from “X” and a ±10% variation from “Y” and values therebetween.

Unless defined otherwise, all technical and scientific terms used herein have the same meaning as is commonly understood by one of ordinary skill in the art to which this invention belongs. If a definition set forth in this application is contrary to or otherwise inconsistent with a definition set forth in patents, published patent applications, and other publications that are herein incorporated by reference, the definition explicitly set forth in this application prevails over the definition that is incorporated herein by reference.

As used herein, a “nanostructure” refers to any structure having at least one dimension of about 100 nm or smaller, and a “nanoparticle” refers to any particle having at least one dimension of about 100 nm or smaller. As described herein, a nanoparticle typically has an average cross-sectional dimension that is at most half of that of a nanostructure. Further, a nanoparticle can be of various shapes, including substantially spherical and other geometrical shapes. For example, a metal nanoparticle can be substantially spherical, whereas a metal oxide nanoparticle can be cubic, hetrahedral, octandral, dodecahedral, icosahedral, cuboctahedral, and so forth, depending on the crystalline phase of the metal oxide. The nanoparticle also can be irregularly shaped, for example, when the nanoparticle is of an amorphous metal oxide.

By “disordered array” it is meant that the nanostructures form a framework with no measurable periodic order or pattern to the relative arrangement of nanostructures within the framework, e.g., no regular inter-nanostructure spacings, orientation, rotation, alignment, helicity, and the like. Thus, a “disordered array of nanostructures” encompasses all three-dimensional frameworks of nanostructures in which the nanostructures exhibit some degree of intertwining or entanglement. For example, a disordered array of nanostructures can be characterized as a mesh of nanostructures, a mat of nanostructures, a net of nanostructures or the like. For the sake of simplicity, a disordered array of nanostructures can be referred herein simply as a “nanostructure mat.”

As used herein, “average” is meant to encompass any measure of a typical value of a distribution, e.g., median, mode or mean.

Nanostructured catalysts, methods for catalyzing reactions using the nanostructured catalysts, and examples of reactions that can be catalyzed using the nanostructured catalysts are described herein. In general, the nanostructured catalysts comprise a disordered array (mesh or mat) of nanostructures. The nanostructures can have a variety of configurations (shapes or structure types and dimensions), with non-limiting example including nanosprings, nanorods, nanowires, nanotubes, and combinations thereof. Disposed on the nanostructures within the disordered array are metal-containing (metals, metal alloys, metal oxides, and the like) nanoparticles. In the nanostructured catalysts, the nanoparticles generally have a smaller cross-sectional dimension than the nanostructures to which they are attached. For example, in a disordered array, an average cross-sectional dimension of the nanoparticles can be at most about 1/100, about 1/50, about 1/20, about 1/10, about ⅕, about ¼, about ⅓, or about ½ an average cross-sectional dimension of the nanostructures in that disordered array. Examples of disordered arrays of insulating and semiconducting nanostructures that can be grown on a substrate are provided in International Application No. PCT/US2006/024435, “Method for Manufacture and Coating of Nanostructured Components.”

Such a disordered array or mat of nanostructures can be well-suited for catalytic converter applications because of the potential for a very high surface area to mass ratio, which can result in increased numbers of reactive sites. The nanostructured catalysts described herein can be suitable heterogeneous catalysts or easily separable catalysts with high accessible surface areas that can be specifically modified to catalyze the conversion of pollutants such as CO, NOₓ, SOₓ, and particulates from diesel combustion into less harmful compounds. In some cases, the nanostructured catalysts can be efficient at low temperatures. As demonstrated by the Examples provided hereinbelow, the present nanostructured catalysts can have much improved thermal stability and resistance to sintering (which inactivates the catalysts) compared to similar catalysts otherwise supported on different substrates.

In certain variations, the nanostructured catalysts described herein can be well-suited to catalyze oxidation reactions. Molecular oxygen has been shown to dissociate and fill oxygen vacancies as readily available and highly reactive atomic oxygen. See Zhou et al., J. Catal., 229: 206 (2005). Gas species containing oxygen sometimes do not bind well to metal oxide surfaces without the presence of oxygen vacancies. See Maiti et al., Nano Lett. 3: 1025 (2003). The products of a catalyzed reaction or adsorbed species can desorb from a nanostructured catalyst as described herein with very little energy because the metal ions can easily change valence states, causing a change in the affinity of the products for the metal oxide surface.

### I. Nanostructured Catalysts

A nanostructured catalyst according to the present teachings comprises a disordered array of metalized nanostructures, i.e., a disordered array of nanostructures where each nanostructure is coated with a plurality of metal-containing nanoparticles. The metalized nanostructures provide a macroporous network in which essentially all of the volume within the network may be accessible as a catalytic site. That is, because of the relatively large open volumes between the nanostructures metalized with the nanoparticles, and the relative uniform presence of metal-containing nanoparticles on all or most surfaces of the nanostructures, which are in turn arranged in a disordered manner, reactants are likely to be able to find an accessible catalytic site to which they can be adsorbed or bound and catalyzed by the metal-containing nanoparticles.

In many catalytic systems, a molecular species can be adsorbed onto a catalyst surface. In some situations, the electronic band structure of an adsorbed molecular species can be different than that of the non-adsorbed corresponding species. The electronic state of surface atoms on a nanostructure can change or be changed, e.g., to assist in the adsorption of a molecular species to the surface. The deposition of metal-containing nanoparticles (e.g., zero-dimensional particles, or particles that are sufficiently spread out so as to not form a contiguous one-dimensional, two-dimensional or three-dimensional grouping) onto a nanostructure surface can alter the electronic state of the nanoparticles and/or surface atoms on the nanostructure surface. In some instances, this may lead to novel electronic and/or catalytic properties of a nanostructured catalyst comprising the deposited nanoparticles on the nanostructure surface. For example, a nanostructured catalyst comprising metal-containing nanoparticles deposited, grown, or otherwise disposed on nanostructures can exhibit improved catalytic properties compared to the same metal-containing nanoparticles deposited, grown, or otherwise disposed on non-nanoscale structures.

The adsorption of a molecular species (a reactant) onto the surface of a nanostructure is useful for catalyst application. A change of the electronic band structure of a material as it reaches nanoscale dimensions can be due to an effect of reduced interactions with neighboring atoms. As a result, surface atoms can have the ability to change electronic state and assist the adsorption process. Similarly, the deposition of metal-containing nanoparticles onto a semiconducting nanostructure can alter the electronic state of each of the nanoparticles and nanostructure, thereby imparting novel electronic and catalytic properties to the hierarchical nanostructured assemblies described herein.

As described above, the nanostructured catalysts described here can in some variations comprise a disordered array of nanostructures, where the nanostructures can comprise a variety of structures such as nanosprings, nanowires, nanorods, nanotubes, single strand nanostructures, multistrand nanostructures, and any combination thereof. The disordered array formed by the nanostructures can be disposed on or attached to at least a portion of a substrate, which can be insulating, conductive, or semiconducting.

Nanostructures (e.g., one-dimensional nanostructures) can be well-suited for catalyst applications because of their large surface area to volume ratio, which in general results in orders of magnitude more reactive sites than thin films or bulk materials. As a point of reference, the surface area per mass of silicon nanowires with mean diameters of about 15 nm has been calculated to be about 115 m²/g, which is over about 1000% larger than that of a thick silicon film with 1 mm by 1 mm dimensions.

In general, the disordered array of nanostructures can be grown directly on a substrate including various three-dimensional substrates. The nanostructures can comprise a glass (e.g., silica (SiO₂ or SiOₓ)), a ceramic (e.g., SiC, BN, B₄C or Si₃N₄), a ceramic oxide (e.g., Al₂O₃ or ZrO₂), a metal or semiconductor (e.g., Si, Al, C, Ge, GaN, GaAs, InP or InN).

The disordered array of nanostructures for use in the nanostructured catalysts can be grown in any suitable manner. In some variations, a disordered array of nanostructures for use in the catalysts can be grown by depositing a thin film catalyst on the substrate, heating the thin-film catalyst on the substrate together with gaseous, liquid, and/or solid nanostructure precursor material or materials, and then cooling slowly under a relatively constant flow of gas to room temperature, e.g., generally following the methods for growing nanostructures as described in International Patent Application No. PCT/US2006/024435. If more than one nanostructure precursor material is used, the precursor materials can be added in a serial or parallel manner.

The concentration of precursor material(s) and/or heating time of the pretreated substrate together with the precursor material(s) can be varied to adjust properties of the resultant disordered array of nanostructures (e.g., mesh thickness and/or nanostructure density). Typical heating times are from about 15 minutes to about 60 minutes. Molecular or elemental precursors that exist as gases or low boiling liquids or solids can be used so that processing temperatures as low as about 350° C. can be used. The processing temperature can be sufficiently high for the thin film catalyst to melt, and for the molecular or elemental precursor to decompose into the desired components. These nanostructure-growing processes can allow the use of a wide variety of substrates. For example, metal, glass, semiconducting, or ceramic substrates can be used. In some variations, relatively low-melting point substrates can be used, such as aluminum, or polymeric materials that are inherently conductive (conductive polymers) or have been made conductive with conductive fillers and/or coatings (e.g., polyimides or other polymers or polymer composites having a sufficiently high T_{g} to allow relatively short excursions to about 350° C.).

The thin film catalyst can be applied to the substrate using any suitable method. For example, thin films of metal or metal alloy catalysts can be applied using plating, chemical vapor deposition, plasma enhanced chemical vapor deposition, thermal evaporation, molecular beam epitaxy, electron beam evaporation, pulsed laser deposition, sputtering, and combinations thereof. In general, the thin catalyst film is applied substantially uniformly (e.g., as a contiguous or nearly contiguous uniform layer) to allow for relatively uniform growth of nanostructures. The thickness of the thin film catalyst can be varied to tune properties of the resultant mesh of nanostructures (e.g., a thickness of the mesh and/or a density of the nanostructures). In some variations, the thickness of the thin film catalyst can be from about 5 nm to about 200 nm. Non-limiting examples of materials that can be used as the thin film catalyst include Au, Ag, Fe, FeB, NiB, Fe₃B and Ni₃B. After a thin film catalyst layer has been applied to the substrate, the substrate is heated, in some cases so that the catalyst layer melts to form a liquid, and one or more nanostructure precursor materials are introduced in gaseous form so that they can diffuse into the molten catalytic material to begin catalytic growth of the nanostructures.

In some variations of these processes, a substrate pre-treated with a thin catalytic layer can be heated in a chamber at a relatively constant temperature to generate and maintain a vapor pressure of a nanostructure precursor element. In these variations, non-limiting examples of nanostructure precursor materials include SiH₄, SiH(CH₃)₃, SiCl₄, Si(CH₃)₄, GeH₄, GeCl₄, SbH₃, and AlR₃, where R for example can be a hydrocarbon group.

In other variations of these processes, a substrate pre-treated with a thin catalytic layer can be heated in a chamber together with a solid elemental nanostructure precursor at a relatively constant temperature that is sufficient to generate and maintain a vapor pressure of the nanostructure precursor element. In these variations, non-limiting examples of the solid elemental nanostructure precursor include C, Si, Ga, B, Al, Zr and In. In some of these variations, a second nanostructure precursor can be added into the heated chamber, e.g., by introducing a flow or filling the chamber to a static pressure. Non-limiting examples of the second nanostructure precursor include CO₂, CO, NO and NO₂.

In still other variations, a pre-treated substrate can be heated in a chamber to a set temperature at least about 100° C., and a first nanostructure precursor material can be introduced into the chamber through a gas flow while the chamber is heated to the set temperature. After the chamber has reached the set temperature, the temperature can be held relatively constant at the set temperature, and a second nanostructure precursor material can be flowed into the chamber. In these variations, non-limiting examples of the first and/or second nanostructure precursor materials include SiH₄, SiH(CH₃)₃, SiCl₄, Si(CH₃)₄, GeH₄, GeCl₄, SbH₃, AlR₃ (where R is for example a hydrocarbon group), CO₂, CO, NO, NO₂, N₂, O₂, and Cl₂.

A range of densities of nanostructures on the substrate can be made with the methods described here. The density of nanostructures on the substrate can be varied by varying the thickness of the thin film catalyst deposited on the substrate. If the thin film catalyst layer is relatively thick (e.g., 30 nm or thicker), the nanostructures can be very densely packed with nanostructures comprising groups of intertwined and/or entangled nanostructures, e.g., nanosprings, or a combination of nanostructures. A relatively thin catalyst film (e.g., about 10 nm or thinner) can result in nanostructures that may be widely spaced apart, e.g., about 1 μm apart or even farther). For example, an areal density of nanostructures on the substrate of about 5×10⁷ nanostructures per square cm to about 1×10¹¹ nanostructures per square cm can be achieved.

The areal density of nanostructures on a substrate can be estimated using the initial thickness of the thin film catalyst layer, and the average size of the catalyst particle or droplet left at the end of each nanostructure formed. The initial thickness of the thin film catalyst layer can be determined using an atomic force microscope, by examining a border between a catalyst-coated area (e.g., a gold-coated area) and an uncoated area of the substrate. The average catalyst size can be determined from the wavelength of the catalyst plasmon (e.g., the Au plasmon) obtained from a mesh or mat formed from nanostructures, e.g., nanosprings. In some variations, multiple layers of nanostructures (e.g., nanosprings) can be formed by depositing a catalyst layer onto an existing mat or mesh, whereby nanostructures are grown on top of the existing mat or mesh by the previously described process. This catalyst, for example, can be nanoparticles (e.g., gold nanoparticles) that have been coated onto the nanostructures in the existing mat or mesh.

In some variations, each layer in a mesh or mat can have a depth of about 10 μm, and multiple layers can be built up to provide a mesh or mat that has a depth of about 20 μm, about 30 μm, about 50 μm, about 80 μm, about 100 μm, or even thicker, e.g., about 200 μm. In such a multi-layer approach, nanostructures in different layers can comprise the same or different materials, and can have the same or different shapes. For example, a mesh or mat comprising two or more layers of silica nanostructures can be fabricated, or a mesh or mat comprising one or more layers of silica nanostructure and one or more layers of nanostructure comprising a metal oxide, such as ZnO or CeO₂ can be obtained.

As stated above, the nanostructures can have any suitable shape and/or dimensions. For example, the nanostructures can comprise nanowires, nanotubes, nanosprings, nanorods, nanohorns, single strand or multi-strand, or any combination thereof. The nanostructures can range from less than about a micron to about 10 microns in length, and have a cross-sectional dimension from about 5 nm to about 500 nm, e.g., about 5 nm to about 300 nm, or about 5 nm to about 100 nm. Within a mat or mesh, nanostructures having a substantial variation in cross-sectional dimensions can be present. That is, within a mat or mesh, nanostructures having a cross-sectional dimension from about 5 nm to about 100 nm, or from about 5 nm to about 200 nm, or from about 5 nm to about 300 nm, or from about 5 nm to about 400 nm, or from about 5 nm to about 500 nm, or from about 15 nm to about 500 nm, can be present. The nanostructures can have any suitable cross-sectional shape, e.g., round, oval, hexagonal, elongated (e.g., ribbon-like), and the like.

The structure of certain nanoparticles can affect their catalytic activity. Metal-containing nanoparticles can serve as extremely active sites for the adsorption and dissociation of molecules due to unique electrical properties caused by quantum effects. As metal particles reach the nanometer size range, their energy bands become quantized rather than nearly continuous, as is the case in the bulk material. A shift in Fermi Energy (E_{F}) can lead to semiconductor behavior. Semiconductor behavior can enhance the ability of the nanoparticles to adsorb and dissociate reactant species. In particular nanoparticles of metals that have either d-band vacancies or easily ionized d-bands (e.g., Au, Fe, Co, Ni, Cu, Rh, Pd and Ag) can be active in some reactions, e.g., highly active in some cases.

Gold nanoparticles that show semiconductor behavior can in some cases exhibit enhanced catalytic activity. See, e.g., Haruta, Appl. Catal. A: General, 222:427 (2001); Haruta, The Chemical Record, 3: 75 (2003); Chung et al., Appl. Phys. Lett., 76: 2068 (2000); Hanrath et al., J. Am. Chem. Soc., 124: 1424 (2002); Guczi et al., J. Am. Chem. Soc., 125: 4332 (2003). Small gold nanoparticles containing 12 or less atoms can be amorphous and can be particularly active for oxidation of CO. See Cunningham et al., J. Catal., 177: 1 (1998).

The shape of metal nanoparticles also can influence their catalytic activity in some cases. Gold nanoparticles with 13 atoms and icosahedral symmetry can be more catalytically active than similarly sized gold nanoparticles having cuboctahedral symmetry. The icosahedral symmetry is constructed of corner atoms bonded to five other atoms, while the cuboctahedral symmetry consists of corner atoms bonded to four other atoms. The icoshedral symmetry and the cuboctahedral symmetry have different band structures. Even particles consisting of 300 gold atoms were shown to have band structures different than those exhibited by bulk gold, although the 300-atom gold particles are less catalytically active than smaller nanoparticles. See Haruta, The Chemical Record, 3: 75 (2003). The potential energy of a gold nanoparticle is influenced by its nearest neighbors, therefore metals can have drastic changes in particle shape (geometry) and crystal structure between the bulk metal and nanoparticles. Aluminum nanoparticles exhibit a transition in geometry and crystallinity between particles containing several hundred atoms to those containing a few thousand atoms. The activity of transition metal nanoparticles has been studied and appears to be optimal for some reactions for particles having sizes in a range from about 3 nm to about 6 nm. See Schögl, et al., Agnew. Chem. Int. Ed., 43: 1628 (2004).

The catalytic activity of metal nanoparticles also can be affected by the support to which they are attached as described hereinabove. For example, gold nanoparticles supported on metal oxide nanostructures have been demonstrated to act as catalysts in certain examples. See Haruta, The Chemical Record, 3: 75 (2003); Carretin et al., Agnew. Chem. Int. Ed., 43: 2538 (2004); Iizuka et al., J. Catalysis, 187: 50 (1999); Fu et al., Science, 301: 935 (2003). In some cases, a phase boundary between metal nanoparticles and a ceramic support can increase catalytic activity of the metal nanoparticles. For example, for a system comprising gold nanoparticles on a TiO₂ substrate, the gold atoms bonded to Ti and O atoms on the substrate can be the most active atoms in the system. See Campbell, Science, 306: 234 (2004).

Metal-containing (metals, metal alloys, metal oxides, metal complexes, and the like) nanoparticles deposited, grown and/or otherwise provided on the present nanostructures can have any suitable composition and can be present in any suitable size range and density. In general, it may be desired to use metal-containing nanoparticles in the size range from about 2 nm to about 100 nm, or from about 2 nm to about 80 nm, or from about 2 nm to about 50 nm, or from about 2 nm to about 30 nm, or from about 2 nm to about 15 nm, or from about 5 nm to about 15 nm. In some cases, the nanoparticles individually also can have some surface structures, e.g., they may include sub-nanometer features which may contribute to their catalytic activity. In general, the covering of the metal-containing particles on the underlying nanostructure can be sufficient to provide a surface area to mass ratio of at least about 50 m²/g, at least about 75 m²/g, at least about 100 m²/g, at least about 115 m²/g, at least about 125 m²/g, at least about 150 m²/g, at least about 200 m²/g, at least about 250 m²/g, at least about 300 m²/g, at least about 400 m²/g, or at least about 500 m²/g, or even higher. For example, in some variations, a SiO₂ nanospring can be decorated with palladium nanoparticles having an average diameter of about 2 nm to about 15 nm, and can be present in such a density so as to provide a surface area to mass ratio of at least about 80 m²/g, or at least about 90 m²/g, or at least about 100 m²/g, at least about 115 m²/g, or at least about 120 m²/g.

In some variations, it may be desired to utilize metals that have d-band vacancies, or easily ionized d-bands for the nanoparticles in the nanostructured catalysts described here. For example, suitable metals can include Au, Fe, Ni, Cu, Rh, Pt, Pd, Fe, Rh, Mn, Ir, Ag and alloys thereof. In some cases, it may be desired to provide more than one type of nanoparticles on the nanostructures, e.g., a combination of nanoparticles made from different metals, metal alloys, and/or metal oxides, and/or a combination of different particle size distributions of nanoparticles. In some cases, the nanoparticles themselves can comprise more than one type of metal, e.g., nanoparticles comprising an alloy can be used.

Metal-containing particles or metal oxides can be deposited, grown or otherwise provided on the present nanostructures by any suitable technique or combination of techniques. For example, the metal-containing nanoparticles can be applied using atomic layer deposition (ALD), chemical vapor deposition (CVD), plasma-enhanced chemical vapor deposition (PECVD), or spray pyrolysis. In general, the nanoparticles can have an average diameter of about 100 nm or less, about 50 nm or less, about 40 nm or less, about 30 nm or less, about 20 nm or less, or about 10 nm or less, or even smaller, about 5 nm or less, e.g., about 4 nm, about 3 nm, or about 2 nm. Further, the standard deviation of the distribution of nanoparticle diameters applied to the nanostructures can be less than about 100%, less than about 80%, less than about 50%, less than about 30%, less than about 20%, or less than about 10%. In some cases, more than one average size nanoparticle can be applied to the disordered arrays, e.g., in multiple applications. For example, a first application can apply relatively large particle sizes, e.g., about 5 nm to about 50 nm, and the second application can apply relatively smaller particles sizes, e.g., less than about 5 nm.

To achieve a desired particle size distribution and spatial distribution of metal-containing nanoparticles on a disordered array of nanostructures, the nanoparticles can be deposited or grown in such a manner to control average nanoparticle size and distribution. In some variations, the nanoparticles can be grown in a parallel plate PECVD chamber operated at about 13.56 MHz. The chamber volume can be about 1 cubic meter. The parallel plates can be about 3″ in diameter and separated by about 1.5″. A nanoparticle precursor and carrier gas (e.g., argon) mixture can be introduced into the chamber from a nozzle in the center of the anode, and the sample holder can serve as a ground plate. The temperature and the pressure of the deposition process can be varied to vary the average nanoparticle size and particle size distribution. PECVD can be used to grow a variety of metal or metal alloy nanoparticles, with non-limiting examples including Au, Ag, Pt, Ni, Cu, Pd, Ru, Rh, Fe and Co. For example, dimethyl(acetylacetonate)gold(III) can be used as a precursor for gold nanoparticles, bis(cyclopentadienyl)nickel can be used as a precursor for nickel nanoparticles, and (trimethyl)methylcyclopentadienylplatinum(IV) can be used as a precursor for platinum nanoparticles. Each of these precursors is commercially available from Strem Chemicals, Newburyport, Mass..

For example, gold nanoparticles having small average particles sizes and narrow particle size distributions can be produced on a disordered array of nanostructures, e.g., silica nanosprings, using PECVD at pressures between about 17 Pa and 67 Pa, and at substrate temperatures of about 573 K to about 873 K. For example, gold nanoparticles having an average particle diameter of about 5 nm, with a standard deviation of 1 nm can be deposited on silica nanosprings using PECVD with a total chamber pressure of about 17 Pa, a substrate temperature of 573 K, a precursor material of dimethyl(acetylacetonate)gold(III), and argon as a carrier gas. Gold nanoparticles having an average diameter of 7 nm with a standard deviation of 2 nm can be similarly produced, except with a total chamber pressure of 72 Pa and a substrate temperature of 723 K. Gold nanoparticles having an average diameter of 9 nm with a standard deviation of 3 nm can be produced with a total chamber pressure of 17 Pa and a substrate temperature of 873 K. Additional examples of gold nanoparticle distributions that can be formed on silica nanostructures are described in A. LaLonde et al., “Controlled Growth of Gold Nanoparticles on Silica Nanowires,” Journal of Materials Research, 20: 3021 (2005).

In certain variations, the nanoparticles can be distributed on the surface of a nanostructure such that the nanoparticles are generally isolated from each other. For example, there can be physical contact between at most about 10%, at most about 20%, at most about 30%, at most about 40%, or at most about 50% of the particles. If there is physical contact between particles, the contact can be such that adjacent particles abut each other, but a boundary or relatively clear demarcation exists between two abutting particles. The coverage of the underlying nanowire in general may not be complete. In some variations, the coverage of the Pt nanoparticles on the SiO₂ nanowire surface can be about 50% to about 90%, e.g., about 50%, about 60%, about 70%, about 80%, or about 90%. In other variations, the coverage of the nanoparticles on the nanowire surface can be at or close to 100%. In some instances, a boundary separating adjacent or abutting nanoparticles can comprise a disruption between lattice planes of the nanoparticles, e.g., lattice planes across the boundary may not be continuous, there may be a rotation or twist of the lattice planes across the boundary, and/or the lattice planes may be separated by a facet plane at the boundary.

In some variations, the metal-containing nanoparticles on the nanostructures can comprise metal oxides, e.g., zinc oxide, titanium dioxide, cerium oxide, lanthanum oxide, or barium oxide. In some variations, nanoparticles of metal oxides can be applied to nanostructures using atomic layer deposition (ALD). In these variations, the nanoparticle size, distribution, and/or crystalline phase can be controlled by varying the nanoparticle precursor material pressure, purge time, and number of deposition cycles. For example, nanostructures can be metalized with a contiguous uniform coating of zinc oxide nanoparticles, titanium dioxide nanoparticles, cerium oxide nanoparticles, lanthanum oxide nanoparticles, or barium oxide nanoparticles having an average dimension of about 100 nm or smaller, or about 50 nm or smaller. For depositing metal oxides, any suitable atomic layer deposition conditions known in the art may be used. For example, zinc oxide nanoparticles can be deposited using the procedures disclosed in E. B. Yousfi et al., “Atomic layer deposition of zinc oxide and indium sulfide layers for Cu(In,Ga)Se₂ thin-film solar cells,” Thin Solid Films, 387: 29 (2002).

### II. Modifying Nanostructured Catalysts for Catalyzing Specific Reactions

In a heterogeneously catalyzed chemical reaction, the catalyst provides catalytic sites on its surface into and onto which the reactants can diffuse and adsorb. After the reaction, the products desorb from these sites and then diffuse away. The number of catalytic sites on the surface of a catalyst and the accessibility of these sites are thus important factors in affecting reaction rates. Nanostructured catalysts with high accessible surface area as described herein thus provide a good platform for heterogeneous catalysis chemical reactions. One specific advantage of the nanostructured catalysts described herein is that the catalytic activity and/or selectivity of the catalysts can be modified or tuned to catalyze specific chemical reactions by selecting: 1) the size of the accessible catalytic sites in the macroporous network; 2) at least the identity of one of the metals contained in the nanoparticles and the average cross-sectional dimension of the nanoparticles; and 3) the compositions of the nanoparticles and nanostructures where there is an electronic interaction between the nanostructures and the nanoparticles.

The hierarchical structure of the nanostructured catalysts described herein provide many levers (which may in many cases be independently varied) with which to adjust reactivity and/or selectivity of the catalysts, for example: i) the composition of the nanostructures; ii) the configurations of the nanostructures (e.g., shape or structure type, and dimensions of the structures); iii) the density of the nanostructures within the disordered array; iv) the composition of the nanoparticles; v) the size of the nanoparticles; vi) the distribution of the nanoparticles on the nanostructures; vii) electronic interactions between the nanoparticles and the nanostructures; viii) interactions among different types of nanoparticles, particularly, where there are one or more types of metal nanoparticles and/or metal oxide nanoparticles; ix) the layering of metal oxide and nanoparticles; x) the size of accessible catalytic sites that are present in the macroporous network formed by the disordered array of metalized nanostructures described herein; and xi) the spatial distribution of accessible catalytic sites that are present in the macroporous network. Any one of or any combination of these variables can be changed to adapt the nanostructured catalysts for a specific reaction, so that they are versatile and broadly applicable. In some cases, two or more of these variables can be modified independently of each other (e.g., nanoparticle size and composition can be changed independently of the type and density of nanostructures), whereas in other cases variables can be coupled (the size of accessible catalytic sites can depend on the density of nanostructures, configuration of nanostructures, nanoparticle size, and nanoparticle distribution on nanostructures). Selected combinations of these variables can be changed to modify the performance of a catalyst to suit a particular reaction.

In one variation, the catalytic activity of the nanostructured catalyst is modified or tuned by selecting the size of the accessible catalytic sites in the macroporous network. Accessible catalytic sites with a certain size may allow some molecules of certain size, shape and/or physical state to enter under the reaction conditions while excluding others. For example, if the reactant of a specific chemical reaction is in its liquid phase under the reaction conditions, the rate-limiting step of this catalyzed chemical reaction can be the diffusion of the reactant molecules into the accessible catalytic sites. In such case, a nanostructured catalyst with large size of accessible catalytic sites might be preferred over one with relative small size of accessible catalytic sites. However, the total number of accessible catalytic sites is typically diminished when a large size of accessible catalytic sites is selected to enhance the diffusion process of reactant molecules (all other factors being equal) because of fewer nanostructures and nanoparticles being present in the catalyst. As a result, the size of accessible catalytic sites may be selected to provide the desired level of catalytic activity. Further, the size of accessible catalytic sites can be selected to provide both the desired level of activity and selectivity for a mixture of reactants that the catalyst will contact. The size of accessible catalytic sites can be selected to admit smaller molecules while excluding most large molecules from contacting nanoparticles beneath the outer surface of and within the disordered array of nanostructures. One may therefore select the size of accessible catalytic sites to allow a desired rate of diffusion, activity, and selectivity for a particular reactant to contact the catalyst.

In some embodiments, the size of accessible catalytic sites can be tuned by adjusting the configurations of the nanostructures in the disordered array. In the disordered array, the nanostructures can be selected from the group consisting of nanowires, nanotubes, nanorods, nanosprings, and combinations thereof. The nanostructures in a disordered array can have similar configurations (e.g., essentially all nanosprings) or different structures (e.g., a mixture of nanowires and nanosprings).

In some other variations, the size of accessible catalytic sites can be modified or tuned by choosing different cross-sectional shapes of the nanostructures in the disordered array. The cross-sectional shape can be round, oval, hexagonal or elongated (e.g., ribbon-like), and the like.

Alternatively to or in addition to varying the nanostructure configurations and/or cross-sectional shape of nanostructures in a disordered array, the size of accessible catalytic sites can be modified or tuned by selecting a density, and/or thickness, and/or length of nanostructures in the disordered array. As described above, in some variations, the nanostructures can be grown by depositing a thin film catalyst on the substrate, heating the thin-film catalyst on the substrate together with gaseous, liquid, and/or solid nanostructure precursor material(s), and then cooling slowly under a relatively constant flow of gas to room temperature. In some variations, the density, thickness and length of nanostructures can be adjusted by varying precursor material(s), and/or adjusting the concentration of precursor material(s), and/or heating time of the pretreated substrate, and/or the thickness of the thin film catalyst. Further, the nanostructures in a disordered array can have similar dimensions (e.g., having similar cross-sectional dimensions or lengths) or different dimensions (e.g., a mixture of relatively thick nanostructures with relatively thin nanowires or a mixture of relatively long nanostructures with relatively short nanostructures).

In some other variations, the catalytic activity and/or selectivity of the catalysts is modified or tuned by selecting at least one of metal-containing nanoparticles and the average cross-sectional dimension of the nanoparticles. In some variations, the metal-containing nanoparticles can comprise Au, Fe, Ni, Cu, Rh, Ru, Pt, Pd, Fe, Ag and alloys and combinations thereof. In some variations, the average cross-sectional dimension of the nanoparticles may be in the size range from about 2 nm to about 100 nm, or from about 2 nm to about 80 nm, or from about 2 nm to about 50 nm, or from about 2 nm to about 30 nm, or from about 2 nm to about 15 nm, or from about 5 nm to about 15 nm.

The nanostructured catalysts described herein can be engineered to catalyze a range of different chemical reactions depending on the specific material combination of the nanostructure support and the metal-containing nanoparticles and the specific size of accessible catalytic sites. For example, for certain reactions with larger reactants molecules, a catalysis device comprising a macroporous network comprising relatively fewer accessible catalytic sites but having relatively large size of accessible catalytic sites may be preferred over a catalysis device comprising a macroporous network comprising relatively more catalytic sites having relatively small size of accessible catalytic sites.

### III. Emission Control Applications

The nanostructured catalysts described herein can be used for the catalytic conversion of exhaust gases from internal combustion engines, for example, to oxidize carbon monoxide and unburned hydrocarbons into carbon dioxide, to reduce nitrogen oxides into nitrogen, and/or to oxidize soot particles thereby lowering their combustion temperatures.

Emission control systems for purifying exhaust gases from internal combustion engines typically include a catalytic converter that incorporates an oxidation catalyst for oxidizing carbon monoxide and unburned hydrocarbons. While construction may vary, a catalytic converter generally includes a monolithic substrate on which there is a catalytic coating, a supporting mat encircling the peripheral surface of the monolithic substrate, and a metal housing enclosing the monolithic substrate and the supporting mat. The monolith usually has a honeycomb-type structure which has a plurality of longitudinal channels, typically in parallel, to provide a catalytically coated body having a high surface area. The oxidation catalyst(s) typically is impregnated in a washcoat applied to the surface of the monolithic substrate. Oxidation catalysts typically include one or more precious metals such as platinum group metals dispersed on a refractory metal oxide support.

In addition to carbon monoxide and unburned hydrocarbons, exhaust from diesel engines and lean burn gasoline engines also include particulate matter (PM) and a significant amount of nitrogen oxides (NOₓ) which require filtering and purification. Accordingly, emission control systems for diesel engines and lean burn gasoline engines typically also include a particulate filter and a NOₓ storage catalyst. The particulate filter can include an oxidation catalyst that allows unplugging of the filter in a catalyzed reaction. Monolithic substrates similar to those used in catalytic converters can be used in particulate filter applications. However, for particulate filters, the channels are blocked or plugged at one end, with adjacent channels blocked at opposite end-faces. Soot particles are captured within the channel walls as exhaust gases permeate through the channels.

The monolithic substrate typically has a ceramic (e.g., cordierite) or metal honeycomb structure. The honeycomb monolith comprises thin, parallel gas flow channels extending from the inlet face to the outlet face. These channels, which are essentially straight paths from their fluid inlet to their fluid outlet, are defined by walls on which the present metalized nanostructures can be coated so that exhaust gases flowing through the channels can contact the catalytic metal nanoparticles. The thin-walled channels can be of any suitable cross-sectional shape and size such as trapezoidal, rectangular, square, sinusoidal, hexagonal, oval, circular, etc.

Nanostructured catalysts described herein can be deposited within the channels (attached to the channel walls) of standard monolithic substrates used in existing catalytic converter and particulate filter applications, providing improved catalytic converter insert materials and particulate filters with increased catalytic activity, lower light-off temperatures, longer stability and/or lower platinum group metal loading. Specifically, the disordered array of nanostructures (e.g., silica nanosprings) can be applied uniformly inside and along the channels of the monolithic substrate, followed by metallization with one or more types of metal-containing nanoparticles. In various embodiments, the nanostructures can be coated with nanoparticles of an oxidation catalyst, typically nanoparticles of one or more precious metals. For example, Pt, Pd, Rh, Pt—Pd, or Rh—Pt nanoparticles can be deposited on the nanostructures by CVD using suitable metal precursors (e.g., nitrate salts of the metal) with a reducing agent such as H₂. In various embodiments, the nanostructures also can be coated with at least one type of metal oxide nanoparticles. For example, nanoparticles of one or more of barium oxide, cerium oxide, and lathanum oxide can be deposited on the nanostructure surface or on the metal nanoparticles using ALD, in which a suitable reactive metal precursor (e.g., a metal chloride precursor) is introduced in a first step, and after a purge, an oxidizing agent (typically H₂O) is introduced in a second step. Spray pyrolysis also can be used to provide metal-containing nanoparticles on the nanostructures. As demonstrated in the Examples, metal-containing nanoparticles supported by the present nanostructures exhibit significantly improved thermal stability and reduced sintering effect compared to otherwise similar nanoparticles but supported on different substrates. Such resistance to sintering translates to a longer lifetime of the metal catalyst. The present nanostructures themselves also have been shown to exhibit remarkable thermal stability up to temperatures of about 1025° C. in air, making the present nanostructured catalyst extremely suitable for exhaust control systems which operate at a typical temperature range of about 500° C.-650° C. Further, due to the increase in accessible catalytic sites, catalytic converters incorporating the present nanostructured catalyst can include a lower platinum group metal loading without comprising reactivity. For example, compared to a platinum group metal loading of about 40 g/ft³ in current standard catalytic converter insert materials, the present nanostructured catalyst can achieve similar activity at a platinum group metal loading of about 6-30 g/ft³.

In certain variations, a catalytic converter insert material can comprise mats of SiO₂ nanosprings coated with platinum nanoparticles in concert with cerium oxide nanoparticles. Such insert material can be used to produce carbon dioxide from an exhaust gas mixture containing carbon monoxide, hydrocarbons and water at typical operating conditions of a gasoline or diesel engine. Both carbon monoxide and water are Lewis bases, and thus have the ability to donate electron density (via surface association) to metal-containing nanoparticles. Carbon monoxide can also accept electron density from the metal particle via a backbonding interaction. In a backbonding interaction, electron density is transferred into the antibonding orbitals of the carbon monoxide π-bond, weakening the C—O bond and labalizing the heterodiatomic molecule. Under these conditions, and in the presence of a second Lewis base, an atom transfer reaction can be catalyzed. Specifically, an oxygen atom is transferred to a carbon monoxide molecule to yield carbon dioxide and a reduced oxygen donor molecule is catalyzed at the interface of a nanostructure comprising a metal oxide nanoparticle and a metal or metal alloy nanoparticle.

The elements for reactivity comprise an oxygen acceptor that can be activated upon interaction with a metal surface (e.g., carbon monoxide, similar molecules containing π-bonds) and an oxygen donor capable of coordinating a metal surface (e.g., H₂O). The particular products will be determined by the identity of the particular donor and acceptor used, with the common element being an oxygen atom transfer from the donor to the acceptor. In one particular embodiment, the oxygen atom from water is transferred to the carbon monoxide yielding carbon dioxide and hydrogen.

The methods for coating nanostructures on catalytic converter insert materials described herein are applicable to all types of catalytic converter insert materials, both ceramic and metal. The nanostructures cover the interior surfaces (e.g., channels) of the insert materials, thereby greatly enhancing the surface area of the insert material. This is in contrast to washcoat technology that reduces the surface area of the substrate. Nevertheless, substrates having been pre-treated with standard washcoat compositions also can be used with the present nanostructured catalysts. Examples of standard washcoat compositions include alumina, ceria, lanthana, γ-alumina and ceria, and γ-alumina and lanthana.

Coating the substrate interior walls with metalized nanostructures constitutes a unique method of enhancing catalytic converter technology. This affords a catalyst that has better exposure to exhaust gases among other advantages described herein.

### IV. Examples

### Example 1

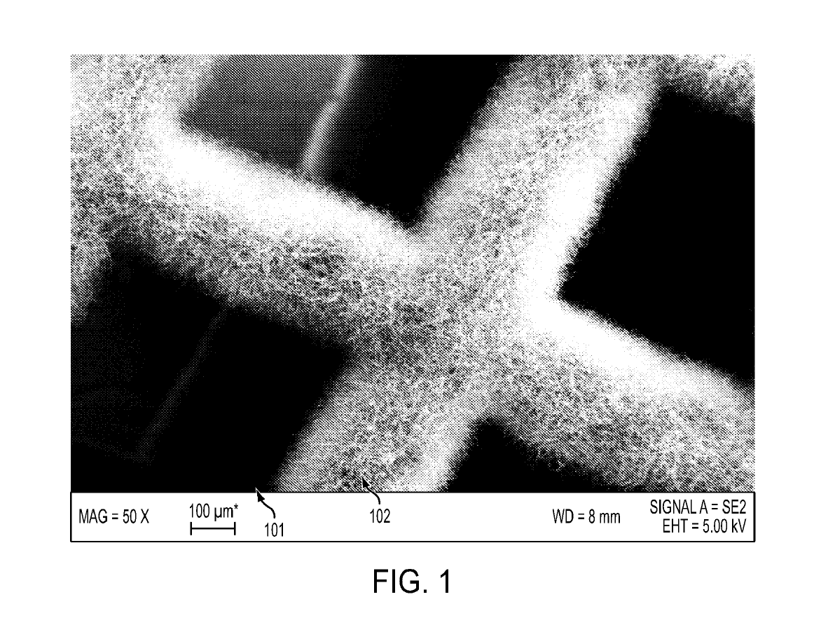

Nanostructures (102) grown on a cordierite honeycomb having parallel channels (101) (FIG. 1), where the nanostructures are coated with a combination of platinum/palladium nanoparticles and/or rhodium/platinum nanoparticles would be able to function in the same manner as a current generation 3-way catalytic converter. Nanostructures coated with cerium oxide will function as the oxygen storage catalyst component. CeO₂ can be deposited under or over the precious metal coating.

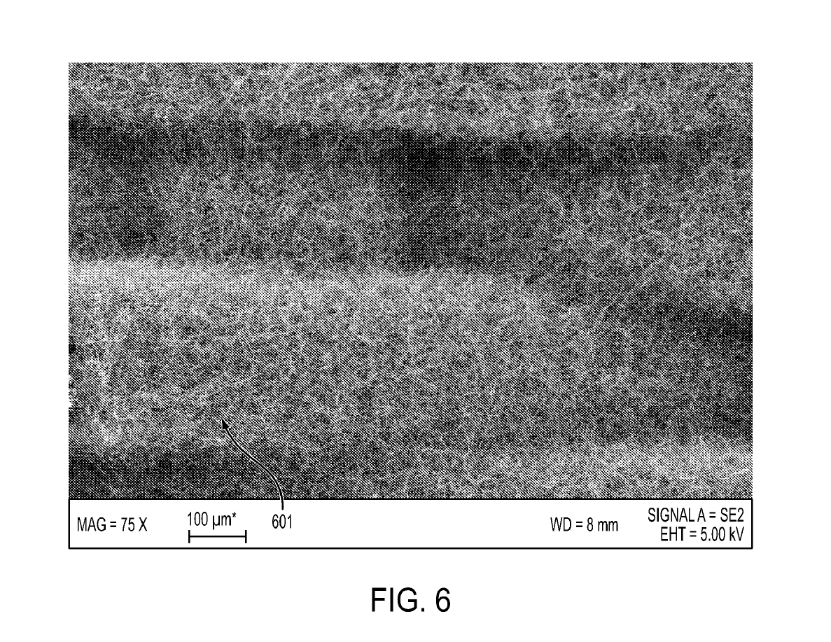

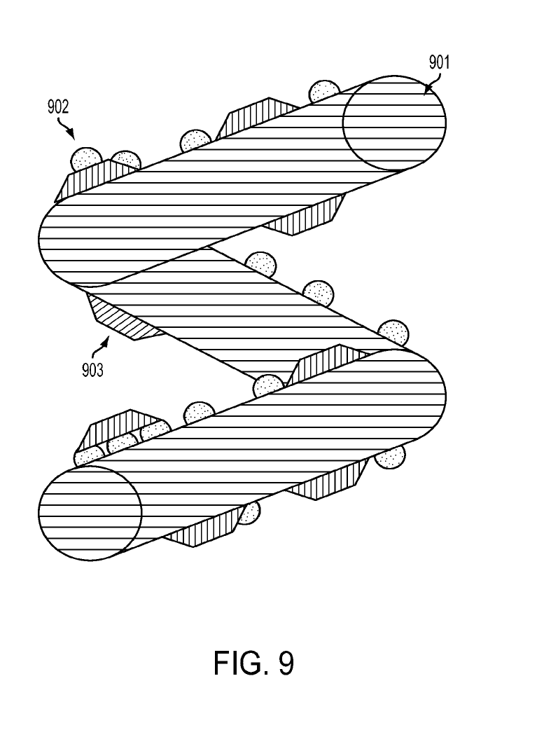

In another variation, nanostructures grown on fiberglass or a porous filter type substrate (FIG. 6) coated with a combination of platinum/palladium nanoparticles and/or rhodium/platinum nanoparticles also would be able to function in the same manner as a 3-way catalytic converter. Nanostructures coated with cerium oxide will function as the oxygen storage catalyst component. CeO₂ can be deposited under or over the precious metal coating. FIG. 9 shows possible combinations for metal nanoparticles and metal oxide nanoparticles such as cerium oxide. Metalized nanostructures grown on fiberglass or a porous filter type substrates can be used in small appliance applications such as lawn mowers.

### Example 2

A variation of silica nanostructures grown on cordierite coated with platinum nanoparticles and barium oxide could be used as lean burn catalytic converters. This type of application can be used as an alternative to 3 way catalysts to reduce NOₓ and oxidize both carbon monoxide and hydrocarbons. These inserts would have applications in diesel and gas engine technologies.

### Example 3

A variation of silica nanostructures grown on diesel particulate filters and coated with palladium nanoparticles can be used to capture and burn carbon particulates.

A variation of nanostructures grown on fiberglass or similar porous filter type substrate and coated with palladium nanoparticles can be used to capture and convert burn carbon particulates.

### Example 4

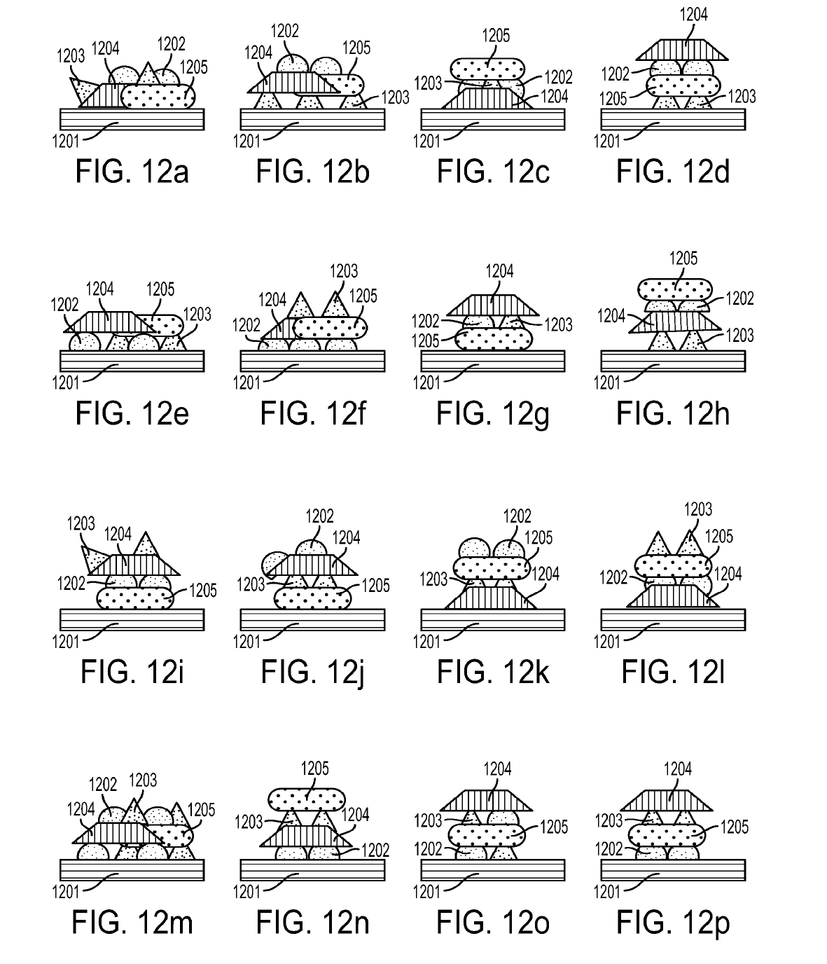

A variation of nanostructures grown on honeycombs and coated with lanthanum oxide as a high temperature stabilizer in any combination with any of the above options can be used as a catalytic converter insert. Different combinations are illustrated in FIG. 12.

### Example 5

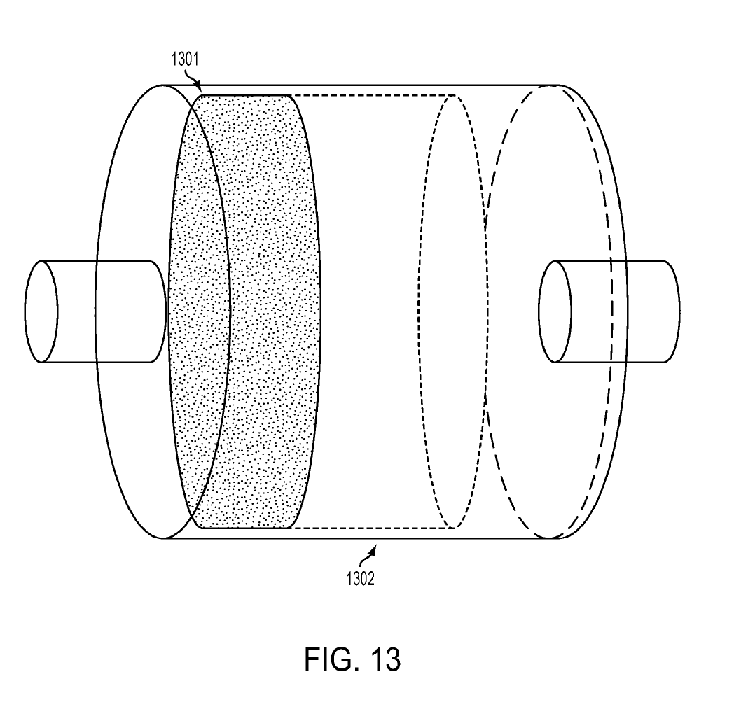

FIG. 13 shows the possible size reduction between the present nanospring-coated insert material (hatched) and existing inserts (dotted line).

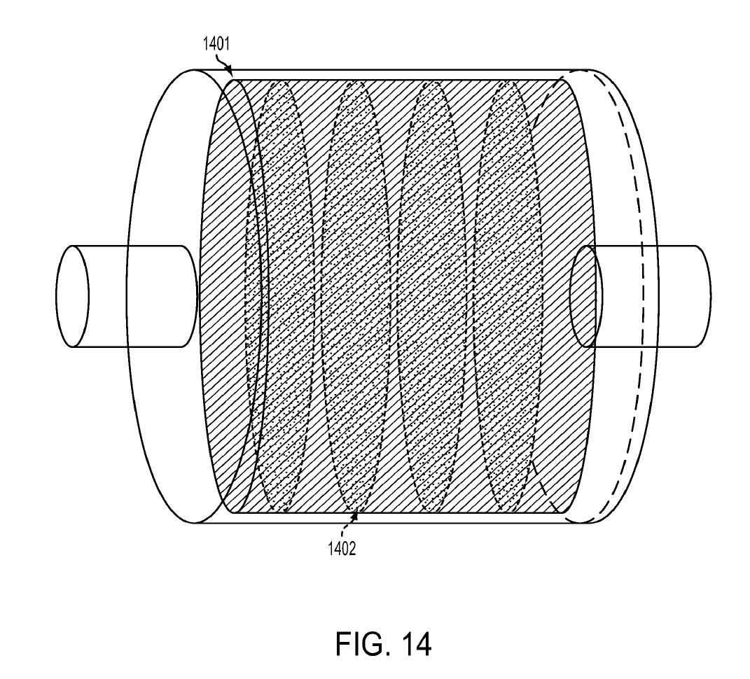

FIG. 14 shows a possible mechanism for holding a porous filter type substrate in a direct flow stream similar to a normal honeycomb insert. Porous filter type substrate pieces (1402) are immobilized by a cylindrical holder (1401).

### Example 6

This example demonstrates that the present nanostructured catalyst exhibits significantly reduced ripening effect at high temperatures. Ripening refers to the thermally-induced growth in particular size of catalytic metal nanoparticles, which inactivates the metal catalyst thereby reducing its useful life.

The following protocol was used to test the thermal stability of metal nanoparticles supported on a disordered array of nanostructures according to the present teachings. Specifically, the nanostructured catalyst was heated at 1073 K for 16 hours under a flow of air with a 10% of relative humidity. These conditions simulate the aging of a diesel catalytic converter mounted on a 100,000 mile vehicle.

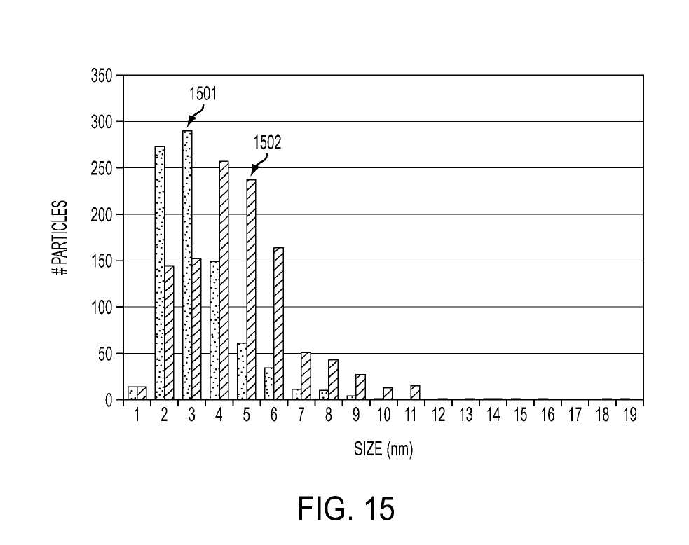

FIG. 15 shows results with nanostructures coated with palladium nanoparticles. It can be seen that the average particle size of the palladium nanoparticles increased slightly from 3.29 nm of the pre-aged sample to 4.68 nm of the post-aged sample, thus showing minimal sintering effect.

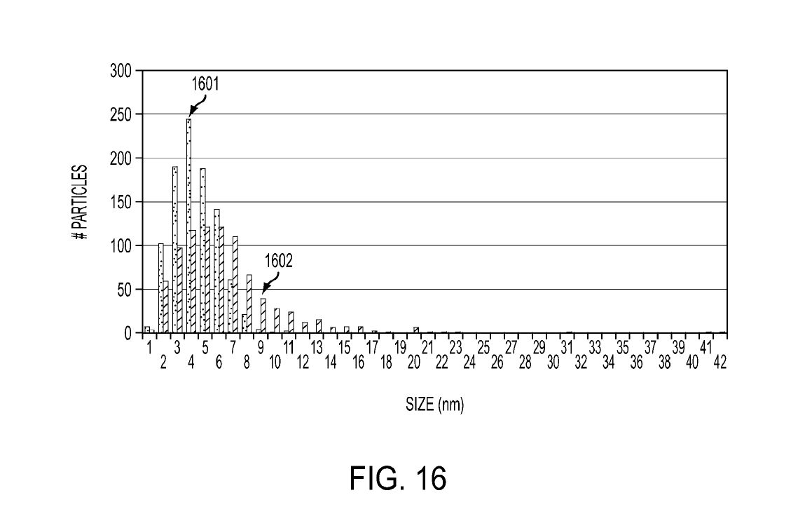

FIG. 16 shows results with nanostructures coated with platinum nanoparticles. It can be seen that the average particle size of the platinum nanoparticles increased slightly from 4.38 nm of the pre-aged sample to 6.37 nm of the post-aged sample, again showing minimal sintering effect.

The following table compares these results with literature values reported with platinum and palladium nanoparticles supported on different substrates.

| | Nanosprings | | γ-Al₂O₃¹ | | | | ZrO₃¹ | | La₂O₃—Al₂O₃² | |
|---|---|---|---|---|---|---|---|---|---|---|
| Support | fresh | aged | fresh | | aged | | fresh | aged | fresh | aged |
| Pt | 4.38 nm | 6.37 nm | <2 | nm | 23 | nm | <2 nm | 15 nm | <5 nm | 78 nm |
| Pd | 3.29 nm | 4.68 nm | 7.3³ | nm | 10.3³ | nm | | | <5 nm | 68 nm |

¹Conditions: 1073K for 5 hours, most probably vacuum; see A. Suzuki et al., “Multi-scale Theoretical Study of Sintering Dynamics of Pt for Automotive Catalyst-SAE International Journal of Fuels and Lubricants,” SAE International Journal of Fuels and Lubricants, vol. 2, pp. 337-345 (2010).
²Conditions: 1373K, exhaust gas; see P. Forzatti and L. Lietti, “Catalyst deactivation,” Catalysis Today, vol. 52, no. 2, pp. 165-181 (1999).
³Conditions: 973K for 7 hours, 10% RH; see R. Liu, P. A. Crozier, C. M. Smith, D. A. Hucul, J. Blackson, and G. Salaita, “In Situ Electron Microscopy Studies of the Sintering of Palladium Nanoparticles on Alumina during Catalyst Regeneration Processes,” Microscopy and Microanalysis, vol. 10, no. 01 (2004).

This disclosure is illustrative and not limiting. Further modifications will be apparent to one skilled in the art in light of this disclosure and such modifications are intended to fall within the scope of the appended claims. Each publication and patent application cited in the specification is incorporated herein by reference in its entirety as if each individual publication or patent application were specifically and individually put forth herein.

What is claimed is:

1. A catalytic converter for purifying exhaust gases from an internal combustion engine, comprising:
a monolithic substrate having a peripheral surface;
a supporting mat encircling the peripheral surface of the monolithic substrate; and
a metal housing enclosing the monolithic substrate and the supporting mat;
wherein the monolithic substrate has a plurality of parallel channels extending therethrough and disposed within at least a portion of each channel is a disordered array of nanostructures, each nanostructure comprising a plurality of metal-containing nanoparticles deposited thereon.

2. The catalytic converter of claim 1, wherein the disordered array of nanostructures comprise nanosprings or a mixture of nanosprings and nanowires.

3. The catalytic converter of claim 2, wherein the nanostructures are composed of silica.

4. The catalytic converter of claim 1, wherein the plurality of metal-containing nanoparticles comprise metal nanoparticles, metal oxide nanoparticles, and combinations thereof

5. The catalytic converter of claim 4, wherein the metal nanoparticles comprise a metal selected from the group consisting of Au, Ag, Cu, Fe, Ni, Pt, Pd, Ir, Rh, Ru, Mn, and Co, or an alloy or a combination thereof.

6. The catalytic converter of claim 4, wherein the metal nanoparticles comprise one or more metals that catalyze oxidation of carbon monoxide and/or hydrocarbons.

7. The catalytic converter of claim 4, wherein the metal nanoparticles comprise one or more metals that catalyze reduction of nitrogen oxides.

8. The catalytic converter of claim 4, wherein the metal oxide nanoparticles comprise a metal oxide that adsorbs oxygen.

9. The catalytic converter of claim 4, wherein the metal oxide nanoparticles comprise a metal oxide that adsorbs nitrogen oxides.

10. The catalytic converter of claim 1, wherein the plurality of metal-containing nanoparticles comprise a first type of metal-containing nanoparticles and a second type of metal-containing nanoparticles, wherein the first type of metal-containing nanoparticles and the second type of metal-containing nanoparticles are of different compositions.

11. The catalytic converter of claim 1, wherein the plurality of metal-containing nanoparticles comprise a first type of metal-containing nanoparticles, a second type of metal-containing nanoparticles, and a third type of metal-containing nanoparticles, wherein the first type of metal-containing nanoparticles, the second type of metal-containing nanoparticles, and the third type of metal-containing nanoparticles are of different compositions.

12. The catalytic converter of claim 1, wherein the plurality of metal-containing nanoparticles comprise a first type of metal-containing nanoparticles, a second type of metal-containing nanoparticles, a third type of metal-containing nanoparticles, and a fourth type of metal-containing nanoparticles, wherein the first type of metal-containing nanoparticles, the second type of metal-containing nanoparticles, the third type of metal-containing nanoparticles, and the fourth type of metal-containing nanoparticles are of different compositions.

13. The catalytic converter of claim 10, wherein the first type of metal-containing nanoparticles comprise a first type of metal nanoparticles and the second type of metal-containing nanoparticles comprise a second type of metal nanoparticles, wherein the first type of metal nanoparticles and the second type of metal nanoparticles are of different compositions.

14. The catalytic converter of claim 10, wherein the first type of metal-containing nanoparticles comprise metal nanoparticles and the second type of metal-containing nanoparticles comprise metal oxide nanoparticles.

15. The catalytic converter of claim 10, wherein the first type of metal-containing nanoparticles comprise a first type of metal oxide nanoparticles and the second type of metal-containing nanoparticles comprise a second type of metal oxide nanoparticles, wherein the first type of metal oxide nanoparticles and the second type of metal oxide nanoparticles are of different compositions.

16. The catalytic converter of claim 1, wherein each nanostructure comprises one or more types of metal nanoparticles deposited on one or more types of metal oxide nanoparticles.

17. The catalytic converter of claim 1, wherein each nanostructure comprises one or more types of metal oxide nanoparticles deposited on one or more types of metal nanoparticles.

18. The catalytic converter of claim 11, wherein the plurality of metal-containing nanoparticles comprise a first type of metal nanoparticles, a second type of metal nanoparticles, and a first type of metal oxide nanoparticles, and wherein the first type of metal oxide nanoparticles are deposited on the nanostructures, and the first type of metal nanoparticles and the second type of metal nanoparticles are deposited on the first type of metal oxide nanoparticles.

19. The catalytic converter of claim 11, wherein the plurality of metal-containing nanoparticles comprise a first type of metal nanoparticles, a second type of metal nanoparticles, and a first type of metal oxide nanoparticles, and wherein the first type of metal nanoparticles and the second type of metal nanoparticles are deposited on the nanostructures, and the first type of metal oxide nanoparticles are deposited on the first type of metal nanoparticles, the second type of metal nanoparticles, or both.

20. The catalytic converter of claim 1, wherein the disordered array of nanostructures has a thickness between about 10 μm and about 200 μm.

21. A catalytic converter for purifying exhaust gases from a lean burn diesel engine, comprising:
a monolithic substrate having a peripheral surface and a plurality of channels defined by a lattice of interior walls;
a supporting mat encircling the peripheral surface of the monolithic substrate; and
a metal housing enclosing the monolithic substrate and the supporting mat;
wherein attached to at least a portion of the interior walls defining each channel of the monolithic substrate is a disordered array of nanostructures comprising nanosprings or a mixture of nanosprings and nanowires, wherein each nanostructure comprises a plurality of barium oxide nanoparticles and at least one of a plurality of palladium nanoparticles and a plurality of platinum nanoparticles deposited thereon.
